(19) United States
(12) Patent Application Publication
(10) Pub. No.: US 2025/0055654 A1
(43) Pub. Date: Feb. 13, 2025

(54) METHOD FOR SAVING NETWORK ENERGY

(71) Applicant: ZTE Corporation, Shenzhen (CN)

(72) Inventors: Xuan MA, Shenzhen (CN); Mengzhu CHEN, Shenzhen (CN); Qiujin GUO, Shenzhen (CN); Jun XU, Shenzhen (CN); Xiaoying MA, Shenzhen (CN); Bo DAI, Shenzhen (CN)

(21) Appl. No.: 18/930,851

(22) Filed: Oct. 29, 2024

Related U.S. Application Data
(63) Continuation of application No. PCT/CN2022/111831, filed on Aug. 11, 2022.

(51) Int. Cl. H04L 5/00; H04B 7/06; H04L 27/26

(52) U.S. Cl. CPC H04L 5/0092; H04B 7/0626; H04L 27/26025

(57) ABSTRACT

This disclosure is directed to methods, systems, and devices related to wireless communication, and more specifically relates to saving network energy. A method of wireless communication, comprising: receiving, by a wireless communication device, from a network device, one or more of the following information: a first indication, a second indication, a third indication, a fourth indication or a fifth indication; wherein the first to fifth indication information include one or more of the following information: activations of a cell or a cell group, deactivation of the cell or the cell group, a cell state indication, a Bandwidth Part (BWP) indication, a BWP state indication, or a reference signal indication; and operating the wireless communication device according to the receiving.

### CROSS-REFERENCE TO RELATED APPLICATION

This application is a continuation and claims priority to International Application No. PCT/CN2022/111831, filed on Aug. 11, 2022, the disclosure of which is hereby incorporated by reference herein in its entirety.

### TECHNICAL FIELD

This disclosure is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed that can be implemented by embodiments in mobile communication technology, including 5th Generation (5G), new radio (NR), 4th Generation (4G), and long-term evolution (LTE) communication systems.

In one example aspect, a wireless communication method is disclosed. The method includes receiving, by a wireless communication device, from a network device, one or more of the following information: a first indication, a second indication, a third indication, a fourth indication or a fifth indication; wherein the first to fifth indication information include one or more of the following information: activations of a cell or a cell group, deactivation of the cell or the cell group, a cell state indication, a Bandwidth Part (BWP) indication, a BWP state indication, or a reference signal indication; and operating the wireless communication device according to the receiving.

In another example aspect, another wireless communication method is disclosed. The method includes transmitting, by a network device, to a wireless communication device, one or more of the following information: a first indication, a second indication, a third indication, a fourth indication or a fifth indication; wherein the first to fifth indication information include one or more of the following information: activations of a cell or a cell group, deactivation of the cell or the cell group, a cell state indication, a BWP indication, a BWP state indication, or a reference signal indication; and operating the wireless communication device according to the transmitted indication.

In yet another exemplary aspect, the above-described methods are embodied in the form of a computer-readable medium that stores processor-executable code for implementing the method.

In yet another exemplary embodiment, a device that is configured or operable to perform the above-described methods is disclosed. The device comprises a processor configured to implement the method.

The above and other aspects and their implementations are described in greater detail in the drawings, the descriptions, and the claims.

### BRIEF DESCRIPTION OF THE DRAWINGS

FIG. 1 shows an example of a wireless communication system that includes a base station (BS) and user equipment (UE) based on some implementations of the disclosed technology.

FIG. 2 shows an example of a block diagram of a portion of an apparatus based on some implementations of the disclosed technology.

FIG. 3 shows an example of specific state MAC CE.

FIG. 4 shows an example of the combination of (enhanced) SCell activation/Deactivation MAC CE and specific state MAC CE.

FIG. 5 is a flowchart illustrating an example method.

FIG. 6 is a flowchart illustrating an example method.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

5G communication can significantly improve the user experience with higher throughput, massive connections, and various services, such as, eMBB (enhanced Mobile Broadband), URLLC (Ultra Reliable Low Latency Communications), redcap (Reduced Capability), XR (Extended Reality), etc.

The energy consumption and greenhouse gas emission caused by the 5G base stations and user devices have become an acute issue with the deployment of 5G. Network energy saving becomes a critical part for the development of a sustainable and green communication system, and reduction of the operation expense.

In a wireless communication system, the downlink transmission is the main component of network power consumption. Compared with downlink transmission, the uplink transmission consumes a smaller proportion of network energy. Therefore, reducing the power consumption of downlink services is a focus for network energy saving.

According to the current specification, a cell can be de-activated for energy saving. However, with this solution, network has to handover the user devices (UEs) or wireless device to other cells, which has a large impact on system performance and can only be used at an extremely low load scenario. This method is not suitable for certain scenarios. For example, when the downlink service requirement of the gNB is very small, but the uplink service requirement is high, in this scenario, the cell cannot be deactivated because of the uplink transmission requirements.

By comparison, the downlink transmission consumes a larger portion of the network energy than the uplink transmission. Therefore, reducing the power consumption of downlink services is a key point for energy saving.

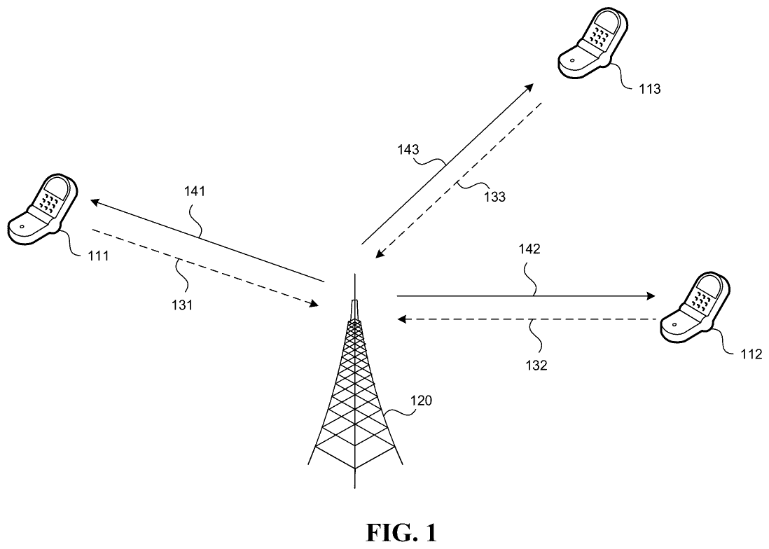

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI (downlink control information) or high layer signaling or downlink information. The UE may be, for example, a smartphone, a tablet, a mobile computer, a machine to machine (M2M) device, a terminal, a mobile device, an Internet of Things (IoT) device, and so on.

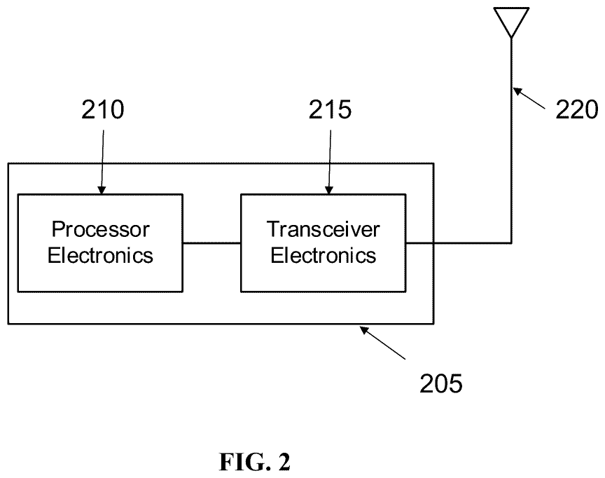

FIG. 2 is a block diagram representation of a portion of an apparatus, in accordance with some embodiments of the presently disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

### 1. Indication Information

The indication information includes at least one of the following: activating a cell, deactivating a cell, indicating a cell state, indicating a BWP, indicating a BWP state, triggering a reference signal.

### 1.1 Activate/Deactivate a Cell

In some examples, UE receives a first indication, the first indication indicates activate or deactivate one or more cells or cell groups. A cell group contains one or more cells.

In some examples, the indication indicates activate or deactivate one or more specific cells or specific cell groups.

In some examples, the specific cell is a first cell where only the uplink transmission is performed on the cell. When the first cell is activated, the uplink BWP (Bandwidth Part) configured by the RRC (Radio Resource Control) parameter (e.g., firstActiveUplinkBWP-Id) is activated on the first cell. One or more of the following operations are performed on the first cell: transmitting the SRS (Sounding Reference Signal) on the cell, reporting the CSI (Channel State Information) on the cell, transmitting the PUCCH (Physical Uplink Control Channel) on the cell (if configured), transmitting the PUSCH (Physical Uplink Shared Channel/Physical Uplink Shared Control Channel) on the cell, transmitting the RACH (Random-Access Channel) on the cell, or transmitting a preamble on the cell.

In some implementations, all the above operations are performed on the activated cell. In some other implementations, any combination of the above operations are performed on the activated cell. One example can be that only SRS and PRACH are transmitted on the activated cell. Another example can be that only SRS and PUSCH are transmitted on the activated cell. In these examples, gNB does not transmit downlink transmission on the first cell, such as not transmit SSB (Synchronization Signal Block) on the cell, not transmit SIB (System Information Block) on the cell, not transmit downlink RS (reference signal) on the cell, not transmit PDCCH (Physical Downlink Control Channel) on the cell, or not transmit downlink (DL)-SCH on the cell.

In some examples, when there is no DL traffic in the first cell, the first cell can be cross-carrier scheduled by another cell. When the first cell is scheduled by a linked scheduling cell, the number of candidates and aggregation levels for the first cell to be used on the linked scheduling cell can be the same as that of the scheduling cell. In some other examples, when the first cell is scheduled by a linked scheduling cell, the number of candidates and aggregation levels for the first cell to be used on the linked scheduling cell can be a default value configured by RRC parameter.

In some other examples, the specific cell is a second cell where limited DL reference signal/channel is performed on the second cell. When the second cell is activated, the DL BWP and UL BWP configured by the RRC parameters (e.g., firstActiveDownlinkBWP-Id and firstActiveUplinkBWP-Id respectively) are activated. One or more of the following operations are performed on the second cell: transmitting the SRS, reporting the CSI, transmitting the PUCCH (if configured), transmitting the PUSCH, transmitting the RACH, not processing the DL common signals/channel, processing the DL common signals/channel with an extended periodicity, detecting the CSI-RS (periodic and/or aperiodic CSI-RS), or detecting on-demand reference signals.

The DL common signal/channel in this document refers to the non-UE-specific downlink signal/channel, which comprises at least one of SSB, SIB, discovery burst, and paging.

When a second cell is activated, gNB transmits limited DL reference signal/channel in the second cell, for example, gNB performs one or more of the following: not transmit the DL common signals/channel on the cell, transmit the DL common signals/channel with an extended periodicity on the cell, not transmit PDCCH on the cell, not transmit DL-SCH (Downlink Shared Channel) on the cell, or transmit on-demand RS on the cell.

The extended periodicity discussed throughout this document is determined by one or more of the following: configured by a high layer parameter, N times of a default periodicity of a signal on legacy SCell, where N≥1, the maximum value can be configured for the signal on legacy SCell, or M times of the maximum periodicity of the signal on legacy SCell, where M≥1.

In some examples, when the specific cell is the first cell that performs only uplink transmission (no downlink service performed on the cell), the first cell is associated with a pre-determined cell. The first cell associated with a pre-determined cell refers to one or more of the following: scheduling information for the first cell is transmitted on the pre-determined cell, indication information for the first cell is transmitted on the pre-determined cell, corresponding timing reference frame of the first cell belongs to the pre-determined cell, system frame boundary, system frame number of the first cell, and the pre-determined cell are the same, the first cell and the pre-determined cell belong to a same timing advance group, a same timing advance offset value applies to both the first cell and pre-determined cell, the uplink frame in the first cell corresponds to the downlink frame in the pre-determined cell (for example, the uplink frame number i in the first cell corresponds to the downlink frame number i in the pre-determined cell), the reference RS (which is configured to obtain spatial relation information) of the UL transmission (e.g. SRS, PUCCH, PUSCH) in the first cell is transmitted on the pre-determined cell, or the pathloss difference between the first cell and the pre-determined cell is no larger than an offset.

When the UE is configured with DLorJoint-TCIState or UL-TCIState, the reference RS in the DLorJoint-TCIState or UL-TCIState can be a resource configured on the pre-determined cell. In some examples, the pre-determined cell comprises one or more of the following: the pre-determined cell configured by a high layer parameter (e.g. configured by RRC), the pre-determined cell is PCell or PSCell, the pre-determined cell and a target cell belong to the same TAG (Timing advance group), the pre-determined cell and the target cell belong to the same frequency range, the pathloss difference between the first cell and the pre-determined cell is no larger than an offset, or the interval between the carrier frequency of pre-determined cell and that of the target cell is smaller than X MHz, where X is a positive number. The target cell is the specific cell.

In some other examples, the UL BWP on the specific cell is linked with the DL BWP on the pre-determined cell. In some examples, the activated UL BWP on the specific cell is linked with the activated DL BWP on the pre-determined cell. When the DL BWP on the pre-determined cell is switched, the UL BWP on the specific cell is not switched accordingly. The UL BWP switching on the specific cell is determined by BWP inactivity timer expiration or by the indication of the bandwidth part indicator carried on DCI format 0_1 or DCI format 0_2 transmitted on the pre-determined cell.

In some other examples, the UL BWP on the specific cell is linked with an DL BWP on the pre-determined cell with the same BWP index. That is, the UL BWP on the specific cell with UL BWP index provided by BWP-Id is linked with a DL BWP on the pre-determined cell with DL BWP index provided by BWP-Id when the DL BWP index and the UL BWP index are same. When the DL BWP on the predetermined cell is switched, the UL BWP on the specific cell is also switched accordingly.

In some other examples, for an unpaired spectrum operation, the UL BWP on the specific cell is linked with an DL BWP on the pre-determined cell with the same BWP index. Otherwise, the activated UL BWP on the specific cell is linked with the activated DL BWP on the pre-determined cell. The UL BWP of the specific cell linked with the DL BWP in pre-determined cell comprises one or more of the following: scheduling information for the specific cell is transmitted on the DL BWP in pre-determined cell, indication information for the specific cell is transmitted on the DL BWP in pre-determined cell, the reference RS (which is configured for obtain spatial relation information) of the UL transmission (e.g. SRS, PUCCH, PUSCH) in the specific cell is detected on the DL BWP of the pre-determined cell, the UL BWP and the DL BWP have the same Subcarrier Spacing (SCS).

In some examples, the pre-determined cell satisfy one or more of the following: the pre-determined cell configured by a high layer parameter (e.g. configured by RRC), the pre-determined cell is PCell or PSCell, the pre-determined cell and the target cell belong to the same TAG (Timing advance group), the pre-determined cell and the target cell belong to the same frequency range, the interval between the carrier frequency of pre-determined cell and that of the target cell is smaller than X MHz, X is a positive number, the pathloss difference between the first cell and the pre-determined cell is no larger than an offset. The target cell is the specific cell.

In some other examples, the specific cell is configured with a particular DL BWP, when the specific cell is activated, the UL BWP and the particular DL BWP are activated. On the particular BWP, limited DL reference signal/channel are transmitted. On the particular BWP, UE performs one or more of the following: not processing the DL common signals/channels, processing the DL common signals/channels with an extended periodicity, detecting the CSI-RS (periodic and/or aperiodic CSI-RS), detecting on-demand reference signals, not monitoring the PDCCH on the BWP; not receiving DL-SCH on the BWP.

For an unpaired spectrum, a DL particular BWP is paired with a UL BWP, and BWP switching is common for both UL and DL. If a BWP is activated on the specific cell and the active DL BWP for the specific cell is a particular BWP, UE performs one or more of the following: transmitting the SRS, reporting the CSI, transmitting the PUCCH (if configured), transmitting the PUSCH, transmitting the RACH, not monitoring the PDCCH on the BWP, not receiving DL-SCH on the BWP, not processing the DL common signals/channels, process the DL common signals/channels with an extended periodicity, detecting the CSI-RS (periodic and/or aperiodic CSI), or receiving on-demand RS.

On the particular BWP, gNB performs one or more of the following: not transmitting DL common signals/channels, transmitting the DL common signals/channels with an extended periodicity, transmitting on-demand RS, transmitting CSI-RS (Channel State Information Reference Signal).

The extended periodicity includes one or more of the following: configured by a high layer parameter, N times of the default periodicity of the signal in legacy cell, where N≥1, the maximum value can be configured for the signal in legacy cell, or M times of the maximum periodicity of the signal in legacy cell, where M≥1.

In some examples, the indication indicates activate a downlink cell, where the downlink cell is linked with an uplink only cell. In some examples, the downlink cell with the same cell index as the activated uplink only cell. In some other examples, the downlink cell index and the uplink cell index are configured separately. When the downlink cell is activated, one or more of the following operations are performed on the cell: monitoring PDCCH, receiving PDSCH, processing SSB, detecting CSI-RS, or detecting on-demand RS.

In some other examples, the indication indicates deactivation of a downlink carrier. When the downlink carrier is deactivated, UE does not receive the downlink signals and channels on the cell. When the DL carrier is deactivated, the uplink transmission on the cell is still active. When the downlink carrier is deactivated, gNB does not transmit DL traffic on the cell, such as, not transmitting PDCCH on the cell, not transmitting PDSCH on the cell, not transmitting SSB on the cell, or not transmitting DL reference signals on the cell.

In some examples, when the DL carrier is deactivated, the UL carrier corresponding to the deactivated DL carrier is associated with a pre-determined cell. In some other examples, when the DL carrier is deactivated, the BWP of the UL carrier corresponding to the deactivated DL carrier links to the BWP in the pre-determined cell. The UL carrier corresponding to the deactivated DL carrier means that the UL carrier and the deactivated DL carrier are configured within one serving cell or the UL carrier and the deactivated DL carrier are activated by same MAC CE. The UL carrier linked with a pre-determined cell refers one or more of the following: scheduling information for the UL carrier is transmitted on the pre-determined cell, indication information for the UL carrier is transmitted on the pre-determined cell, the corresponding timing reference frame of the UL carrier belongs to the pre-determined cell, a same timing advance offset value applies to both the UL carrier and pre-determined cell, the uplink frame of the UL carrier corresponds to the downlink frame in the pre-determined cell (for example, the uplink frame number i in the UL carrier corresponds to the downlink frame number i in the pre-determined cell), the reference RS of the UL transmission (e.g. SRS, PUCCH, PUSCH) in the UL carrier is transmitted on the pre-determined cell. In some embodiments, the reference RS is configured to obtain spatial relation information.

In some examples, the pre-determined cell is configured by RRC parameters. When the DL carrier is deactivated, the link relationship takes effect immediately. In some other examples, the pre-determined cell is indicated by an indication. The indication can be carried by the deactivation indication, or the indication can be a new signal/channel transmitted on the pre-determined cell after the DL carrier is deactivated.

In some other examples, the UL carrier corresponding to the deactivated DL carrier is not associated with any cell. The configurations before the DL carrier was deactivated can still be used for the UL carrier, for example, the search space related configurations, the timing related configurations. The UL carrier corresponding to the deactivated DL carrier means that the UL carrier and the DL carrier are configured within one serving cell or the UL carrier and the deactivated DL carrier are activated by same MAC CE before. The BWP of UL carrier associated with the BWP in pre-determined cell refers to one or more of the following: the scheduling information for the UL carrier is transmitted on the BWP in pre-determined cell, the reference RS of the UL transmission (e.g., SRS, PUCCH, PUSCH) in the UL carrier is transmitted on the activated BWP of the pre-determined cell, the UL BWP and the DL BWP have the same SCS. The pre-determined cell is determined by one or more of the following: the pre-determined cell configured by a high layer parameter (e.g., configured by RRC), the pre-determined cell is PCell or PSCell, the pre-determined cell and the UL carrier belong to the same TAG (Timing advance group), the pre-determined cell and the UL carrier belong to the same frequency range, the interval between the carrier frequency of pre-determined cell and that of the UL carrier is smaller than X MHz, X is a positive number.

In some examples, when downlink carrier is deactivated, there is no self-scheduling in the cell, the cell can be cross-carrier scheduled by another cell. In some other examples, when the downlink carrier is deactivated, for the cell with uplink carrier only scheduled by a linked scheduling cell, the number of candidates and aggregation levels for the uplink carrier to be used on the linked scheduling cell can be the same as that of the scheduling cell. In some other examples, for the cell with uplink carrier only scheduled by a linked scheduling cell, the number of candidates and aggregation levels for the uplink carrier to be used on the linked scheduling cell can be a default value configured by RRC parameter. In some other examples, the candidates and aggregation in the search space configured for the downlink carrier can be stored and used for the uplink carrier with cross-carrier scheduling. For the cell with uplink carrier only scheduled by a linked scheduling cell, the number of candidates and aggregation levels for the uplink carrier to be used on the linked scheduling cell can be the same as that of the downlink carrier before the downlink carrier was deactivated.

In some examples, when the cell or carrier is deactivated, the RRC configurations can be stored. When the cell/carrier is reactivated, it will automatically resume stored RRC configuration before deactivation. In some other examples, when the cell or carrier is deactivated, the RRC configurations can be released. When the cell/carrier is reactivated, the RRC will need to be re-configured. In some other examples, when the cell/carrier is reactivated, a default RRC configurations is adopted.

### 1.2 Indicate a Cell State

In some examples, the UE receives a second indication, the second indication indicates a specific state of one or more SCells (secondary cells) or SCell groups, wherein the specific state is the first SCell state or the second SCell state.

In some examples, the first SCell state refers to that UE does not receive any DL signals or channels on the SCell with the first SCell state, gNB does not transmit DL signals and channels on the SCell when the SCell is in the first SCell state. When the SCell is in the first SCell state, UE performs one or more of the following: transmits SRS on the SCell, reports CSI for the SCell, transmits UL-SCH on the SCell, transmits RACH on the SCell, does not monitor the PDCCH on the SCell, does not transmit PDSCH on the SCell, does not process SSB on the SCell, or does not detect reference signals on the SCell.

In some other examples, UE receives limited DL signals or channels on the SCell with the first SCell state, gNB transmits limited DL signals or channels on the SCell which is in the first SCell state. When the SCell is in the first SCell state, the UE performs one or more of the following: does not monitor the PDCCH, processes the DL common signals/channels with an extended periodicity, detects the CSI-RS (periodic and/or aperiodic CSI-RS), receives on-demand RS, transmits the SRS, reports CSI, transmits PUCCH (if configured), transmits PUSCH, transmits RACH. In some other implementations, for a SCell in the first state, the gNB transmits downlink common signals/channels with an extended periodicity. The UE processes the downlink common signals/channels with an extended periodicity.

In some other examples, the second SCell state is an active state.

### 1.3 Indicate a BWP

In some examples, the UE receives a third indication, the third indication indicates a BWP in one or more SCells or SCell groups.

In some examples, the third indication indicates a first DL BWP. On the first DL BWP, no DL signals/channels are transmitted or limited DL signals/channels are transmitted. UE doesn't receive DL signals and channels on the first BWP or processes the limited DL signals/channels on the first DL BWP. On the first DL BWP, UE follows one or more of the following: does not monitor the PDCCH on the BWP, does not receive DL-SCH on the BWP, does not process the DL common signals/channels on the BWP, processes the DL common signals/channels with an extended periodicity, detects the CSI-RS, receives on-demand RS/SSB. For an unpaired spectrum, a DL BWP is paired with a UL BWP, and BWP switching is common for both UL and DL. When a BWP is activated and the active DL BWP for the SCell is the first BWP, UE follows one of the following: transmits the SRS, reports the CSI, transmits the PUCCH (if configured), transmits the PUSCH, transmits the RACH, does not monitor the PDCCH on the BWP, does not receive DL-SCH on the BWP, does not process the DL common signals/channels on the BWP, processes the DL common signals/channels with an extended periodicity, detects the CSI-RS, receives on-demand RS. The extended periodicity is determined by one or more of the following: configured by a high layer parameter, N times of the default periodicity of the signal in legacy SCell, where N≥1, the maximum value can be configured for the signal in legacy SCell, M times of the maximum periodicity of the signal in legacy SCell, where M≥1.

In some other examples, the BWP is a second BWP. In some examples, the second BWP is a legacy DL BWP with normal DL transmission or a dormant BWP.

In some examples, when the indication indicates a first BWP, UE actives the first BWP. If the current active BWP in the cell is a second BWP, UE switches to the first BWP from the second BWP. If the current active BWP in the cell is a first BWP, UE keeps the current activated BWP active. The first BWP can be configured by the high layer parameter, for example, the first BWP is configured with a specific BWP ID (e.g., EnergySavingBWP-Id). In some other examples, when the indication indicates a second BWP, UE actives the second BWP. If the current active BWP in the cell is a second BWP, UE keeps the current activated BWP active. If the current active BWP in the cell is a first BWP, UE switches to the second BWP from current active BWP, where the second BWP to be activated is determined by one or more of the following: configured by high layer parameter, a BWP with a specified BWP ID, the BWP activated before active the energy saving BWP, the initial BWP, or the default BWP.

### 1.4 Indicate a BWP State

In some examples, the UE receives a fourth indication, where the fourth indication indicates a particular BWP state in one or more SCells or SCell groups.

In some examples, a particular BWP state can be configured for specific DL BWP. In some examples, the specific BWP is configured by a high layer parameter, such as, the specific BWP with the particular state is configured with a specific BWP ID (e.g., EnergySavingBWP-Id). In some other examples, the specified BWP can be a BWP with predefined characteristics. For example, the specific BWP is the default BWP, the initial BWP, the BWP with the lowest bandwidth, or the BWP with the maximum BWP ID. In some other examples, the particular BWP state can be configured for any BWP. In some other examples, the particular BWP state can be configured for any BWP except dormant BWP. In some other examples, whether the BWP can be configured with particular BWP state is determined by UE capability or RRC parameter.

In some examples, the particular BWP state includes one or more of the following: UE does not receive DL common signals/channels, UE receives limited DL common signals/channels. UE receives limited DL common signals/channels comprises one of the following: does not monitor the PDCCH on the specific BWP; does not receive DL-SCH on the specific BWP; processes the DL common signals/channels with an extended periodicity; detects the CSI-RS; receives on-demand RS/SSB.

When the activated DL BWP is in particular BWP state, the uplink BWP can be in an active state, UE follows one or more of the following: transmits the SRS, reports the CSI, transmits the PUCCH (if configured), transmits the PUSCH, transmits the RACH, does not monitor the PDCCH on the BWP; does not receive DL-SCH on the BWP; does not process the DL common signals/channels on the BWP, processes the DL common signals/channels with an extended periodicity, detects the CSI-RS, receives on-demand RS/SSB. When the active DL BWP is in the particular BWP state, gNB performs one or more of the following: does not transmit DL common signals/channels, transmits the DL common signals/channels with an extended periodicity, transmits on-demand RS/SSB, transmits CSI-RS. The extended periodicity is determined by one or more of the following: configured by high layer parameter, N times of the default periodicity of the signal before the particular BWP state introduced, where N≥1, the maximum value can be configured for the signal before the particular BWP state introduced, M times of the maximum periodicity of the signal before the particular BWP state introduced, where M≥1.

In some examples, the indication indicates a particular BWP state, if the current active BWP supports to be configured with the particular BWP state, the UE switches current active BWP from the active state to the particular state. In some examples, the indication indicates a particular BWP state, if the current active BWP doesn't support to be configured with the particular BWP state, the UE switches current BWP to another BWP that supports the particular BWP state.

In some other examples, the indication indicates a non-particular BWP state/active BWP state, the UE switches current BWP from the particular BWP state to the active state, or the UE switches current BWP to another BWP, such as, switches to a default BWP, or switches to an initial BWP.

### 1.5 Indicate a Reference Signal

In some other examples, the UE receives a fifth indication, the fifth indication indicates one or more reference signal or reference signal resource, for example, a TRS, a CSI-RS, a CSI-RS resource, a TRS resource, a CSI-RS resource set, a TRS resource set, an SSB.

The reference signal resource is configured by a high layer parameter. In some examples, the reference signal resource is configured for one or more of the following: a fast SCell activation, a synchronization, an automatic gain control (AGC), a transmission timing adjustment, or a beam management.

In some examples, the reference signal is transmitted on a target cell. In some other examples, the reference signal resource is transmitted on a pre-determined cell. The pre-determined cell follows one or more of the following: the pre-determined cell configured by a high layer parameter (e.g., configured by RRC), the pre-determined cell is PCell or PSCell, the pre-determined cell and the target cell belong to the same TAG (Timing advance group), the pre-determined cell and the target cell belong to the same frequency range. The target cell is one or more of the following: a cell to be activated, a specific cell where no DL common signals/channel transmitted or limited DL common signals/channel transmitted, a cell in particular state with no DL common signals/channel transmitted or limited DL common signals/channel transmitted, or a cell where the active DL BWP is a specific BWP on which no DL common signals/channel transmitted or limited DL common signals/channel transmitted.

In some other examples, the reference signal is configured as a reference RS of the TCI state of the UL transmission (e.g., SRS, PUCCH, PUSCH) in the target SCell. For example, the reference signal is configured as a reference RS of the SRS configured with DLorJoint-TCIState or UL-TCIState or followUnifiedTCIstate-r17 in the target cell, where the target cell is one or more of the following: a cell to be activated, a specific cell, a cell in specific cell state, or a cell where the active BWP is a first BWP. In some examples, the reference signal is configured a quasi co-location relationship ‘typeD’ with the SSB or a CSI-RS resource located in the target cell or the pre-determined cell. For example, the reference signal is configured with a reference to an SS/PBCH block, or a CSI-RS resource configured with qcl-Type set to ‘typeD’, where the SS/PBCH block or the CSI-RS resource is located in the target cell or pre-determined cell.

In some examples, the UE is configured with DLorJoint-TCIState or UL-TCIState, the indicated reference signal resource can be configured as a reference RS of the SRS in the target SCell. In some other examples, the target cell is configured with followUnifiedTCIstate-r17, the indicated reference signal resource can be configured as a reference RS for determining UL TX spatial filter.

### 2. Indication Signaling

One or more of the first to fifth indication is carried by one or more of the following: a RRC signaling, MAC CE, a system information block (SIB), a DCI, or a reference signal.

In some examples, both the first indication and the fifth indication are carried on a MAC CE. In some other examples, the first indication is carried on a MAC CE and the fifth indication is carried on a DCI. In this case, the fifth indication is transmitted after the first indication takes effect, for example, a reference signal is triggered after a first cell activated.

### 2.1 RRC Signaling

In some examples, at least one of the indications is carried by a RRC signaling, UE performs the operation according to the RRC configuration.

### 2.2 MAC CE

In some examples, at least one of the indications is carried by a MAC CE.

In some examples, the MAC CE is a specific SCell activation/deactivation MAC CE. The MAC CE comprises one or more of the following fields: a cell field, a RS field, a reserved field. In some examples, each bit Ci in the cell field indicates an activation/deactivation status of the SCell configured for the MAC entity with SCellIndex equals to i. A Ci field is set to ‘1’ to indicate that the SCell with SCellIndex i shall be activated and a Ci field is set to ‘0’ to indicate that the SCell with SCellIndex i shall be deactivated. In some other examples, the RS field is used to indicates whether there is RS configured for efficient activation of the SCell. The octet RS field corresponds to the SCell that shall be activated according to cell field in ascending order of SCellIndex of the SCell and corresponding Ci is set to 1.

In some other examples, the MAC CE is the SCell Activation/Deactivation MAC CE or an enhanced SCell Activation/Deactivation MAC CE, where the reserved bit is used to indicates the type of the cell to be activated. When the reserved bit is set to 0, the SCell to be activated is a legacy cell before Rel-18. When the reserved bit is set to 1, the SCell to be activated is a specific cell.

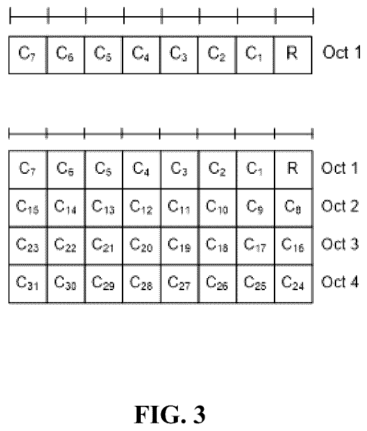

In some other examples, the MAC CE is specific state MAC CE. The specific state MAC CE comprises a cell field and a reserved field, where each bit in the cell field corresponds to one SCell state with a SCellIndex configured by the high layer parameter. As shown in FIG. 3, the specific state MAC CE comprises one or more Octets, e.g., one specific state MAC CE comprises one octet or one specific state MAC CE comprises four octets.

In some examples, the cell field of the specific state MAC CE is used to indicate the SCell state. For an activated SCell configured with SCellIndex i, if the field corresponds to the SCell (e.g., Ci field) in the specific state MAC CE is set to 1, the SCell indicates a first state, if the field corresponds to the SCell (e.g., Ci field) in the specific state MAC CE is set to 0, the SCell indicates a second state. For a deactivated SCell, the MAC entity shall be ignored. When both SCell Activation/Deactivation MAC CE and specific state MAC CE are received or both enhanced SCell Activation/Deactivation MAC CE and specific state MAC CE are received, the SCell state is determined by both SCell Activation/Deactivation MAC CE and specific state MAC CE or both enhanced SCell Activation/Deactivation MAC CE and specific state MAC CE.

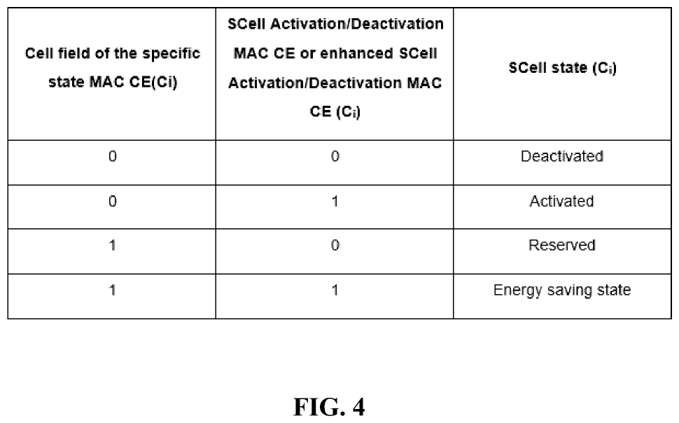

FIG. 4 shows the combination of (enhanced) SCell Activation/Deactivation MAC CE and the specific state MAC CE. Case 1: when the cell field corresponds to the target SCell in the SCell Activation/Deactivation MAC CE or enhanced SCell Activation/Deactivation MAC CE is set to 1, the cell field corresponds to the target SCell in the specific state MAC CE is set to 1, the target SCell should be in the first state. Case 2: when the cell field corresponds to the target SCell in the SCell Activation/Deactivation MAC CE or enhanced SCell

Activation/Deactivation MAC CE is set to 1, the cell field corresponds to the target SCell in the specific state MAC CE is set to 0, the target SCell should be activated (in active state). Case 3:when the cell field corresponds to the target SCell in the SCell Activation/Deactivation MAC CE or enhanced SCell Activation/Deactivation MAC CE is set to 0, the cell field corresponds to the target SCell in the specific state MAC CE is set to 0, the target SCell should be deactivated. Case 4: when the cell field corresponds to the target SCell in the SCell Activation/Deactivation MAC CE or enhanced SCell Activation/Deactivation MAC CE is set to 0, the cell field corresponds to the target SCell in the specific state MAC CE is set to 1, the case can be reserved.

### 2.3 DCI

In some examples, at least one of the indications is carried by a DCI. In some examples, the DCI is a group common DCI transmitted on the PCell or PSCell. UE detects the DCI on the PCell or on the SpCell. In some other examples, the DCI is a cell specific DCI, all the UEs in the cell follows the indications in the DCI. A cell-specific RNTI can be configured for the UE.

In some examples, the DCI comprises a first bit field. In some examples, the first bit field is a bitmap, each bit of the bitmap indicates an active BWP of a SCell or a SCell group. In some examples, a ‘A1’ value of the bit indicates a first BWP and a ‘A2’ value of the bit indicates a second BWP, where B1 equals to 0, A2 equals to 1 or A1 equals to 1, A2 equals to 0. In some other examples, the first bit field indicates BWP IDs. For examples, the first bit fields comprise multiple segments, each segment corresponds to a code point that indicates a BWP ID corresponds to one SCell or one SCell group. When the BWP ID is indicated, the corresponding SCells switch to the indicated BWP.

A UE is expected to provide HARQ-ACK (Hybrid Automatic Repeat Request Acknowledgement) information in response to the DCI indicating a first BWP after S symbols from the last symbol of the PDCCH. Where S>0 and relates to the SCS of the BWP. UE switches the BWP after sending the HARQ-ACK for a period of time.

In some other examples, the DCI comprises a second bit field. In some examples, the second bit field is a bitmap, each bit of the bitmap indicates a BWP state of a SCell or a SCell group. In some examples, a ‘B1’ value of the bit indicates the first BWP state and a ‘B2’ value of the bit indicates an active BWP state, where B1 equals to 0, B2 equals to 1 or BI equals to 1, B2 equals to 0.

A UE is expected to provide HARQ-ACK information in response to the DCI indicating a specific BWP state after X symbols from the last symbol of the PDCCH. Where X>0 and relates to the SCS of the BWP. UE switches the BWP state after sending the HARQ-ACK for a period of time.

In some other examples, the DCI comprises a third bit field. In some examples, the third bit field is a bitmap, each bit of the bitmap indicates a state of a SCell or a SCell group. In some examples, a ‘C1’ value of the bit indicates a first state and a ‘C2’ value of the bit indicates a second state, where C1 equals to 0, C2 equals to 1 or C1 equals to 1, C2 equals to 0. For a deactivated SCell, the indication of the third field is ignored. When the active SCell indicated by the third bit field, the SCell follows the indication. For example, for an active SCell, when the third bit field indicates a first state, the SCell transition to the first state. In some other examples, the third bit field indicates cell IDs. The activated SCell with the cell index indicated by the third field will transition to the first state. The deactivated SCell will ignore the third field.

A UE is expected to provide HARQ-ACK information in response to the DCI indicating a SCell state after Y symbols from the last symbol of the PDCCH. Where Y>0 and related to the SCS of the active BWP on the SCell. UE switches the SCell state after sending the HARQ-ACK for a period of time.

In some other examples, the DCI comprises a fourth bit field. In some examples, the fourth bit field indicates to activate or deactivate one or more carrier/SCell or carrier/SCell group. In some examples, a ‘D1’ value of the bit indicates an activation indication and a ‘D2’ value of the bit indicates a deactivation indication, where DI equals to 0, D2 equals to 1 or DI equals to 1, D2 equals to 0.

In some examples, when the DCI indicates to activate/deactivate a cell/carrier, a UE is expected to provide HARQ-ACK information in response to a detection of the DCI after N symbols from the last symbol of a PDCCH providing the DCI, where N is a positive value. In some other examples, when a UE receives in a DCI an activation command for a carrier/cell ending in slot n, the UE applies the corresponding activation actions no later than n+d1, where d is the effective time of the indication and d1>0. In some other examples, when a UE receives in a DCI a deactivation command for a carrier/cell ending in slot n, the UE applies the corresponding deactivation actions no later than n+d2, where d is the effective time of the indication and d2>0. For example, the UE does not detect reference signals on the cell/carrier from slot n+d2, or UE does not monitor the PDCCH on the cell from slot n+t, where t<d2.

In some other examples, the DCI comprises a fifth bit field. Each bit of the fifth bit field associates a group of RS resource set (e.g., resource signal resource set or reference signal resource set). Each group of RS resource set comprises one or more RS resource set. In some examples, the RS resource is configured on the SCell to be activated. In some other examples, the RS resource is configured on the pre-determined cell. The measurement results of the RS is used for the SCell to be activated.

In some examples, the size of at least one of the first bit field, the second bit field, the third bit field and the fourth bit field is determined by one or more of the following: RRC parameters, the maximum number of cells that can be configured for a UE, the number of configured SCells, the number of activated SCells, the number of groups of configured SCells, where the configured SCell refers to at least one of the SCell configured with a first BWP, the SCell configured with a BWP with particular BWP state, or the SCell can be configured with a particular SCell state.

In some examples, the size of the bit field or the size of the segment of the bit field is equal to the number of configured SCells or the number of groups of configured SCells, and each bit/segment of the bit field corresponds to a configured SCell from the number of configured SCells, or each bit/segment of the bit field corresponds to a group of configured SCells from the number of groups of configured SCells. In some other examples, the size of the bit field or the size of the segment of the bit field is equal to the maximum number of cells that can be configured for a UE, each bit or each segment of the bit field corresponds to one SCell with an ascending cell index.

### 2.4 SIB (System Information Block)

In some examples, at least one of the indications is carried by a SIB. In some examples, at least one of the indications is carried by a new SIB. For example, the new SIB contains information relevant for Cell/carrier activation or deactivation. The uplink cell/carrier list and or the downlink cell/carrier can be configured in the new SIB. When the SIB indicates deactivate a downlink carrier, all the UEs in the cell will deactivate the downlink carrier. In some other examples, at least one of the indications is carried by an existing SIB, for example, SIB1, SIB 17.

### 2.5 Reference Signal

In some examples, at least one of the indications is carried by a reference signal. In some examples, the initialization seeds of signals are related to cell index. When the reference signal is received, the corresponding cell will be activated or deactivated. In some other examples, when the reference signal is received, the corresponding cell will switch to a specific cell state.

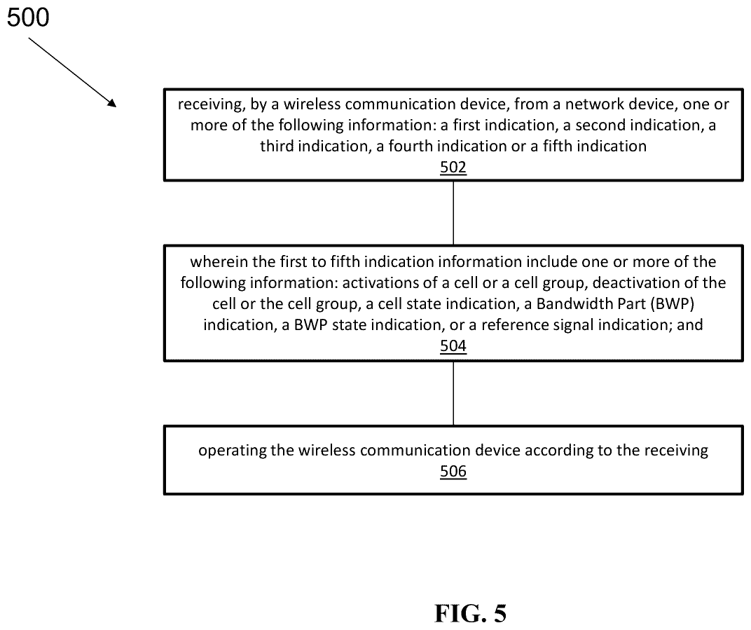

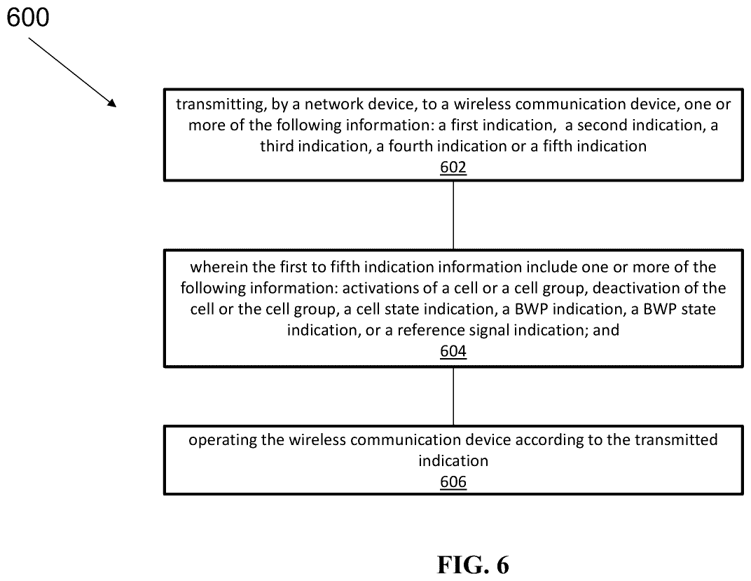

Some preferred embodiments may use the following solutions.
1. A method of wireless communication (e.g., method 500 depicted in FIG. 5) including receiving, by a wireless communication device, from a network device, one or more of the following information: a first indication, a second indication, a third indication, a fourth indication or a fifth indication (502); wherein the first to fifth indication information include one or more of the following information: activations of a cell or a cell group (as described in Section 1.1), deactivation of the cell or the cell group (as described in Section 1.1), a cell state indication (as described in Section 1.2), a Bandwidth Part (BWP) indication (as described in Section 1.3), a BWP state indication (as described in Section 1.4), or a reference signal indication (as described in Section 1.5) (504); and operating the wireless communication device according to the receiving (506). Detailed discussion is described in Section 1. Indication information.
2. The method of solution 1, wherein one or more of the first to fifth indication information is carried by one or more of the following transmission signals: a Radio Resource Control (RRC) signaling, a Medium Access Control-Control Element (MAC-CE) signaling, a downlink control information (DCI) signaling, a reference signal, or a system information block (SIB). Detailed discussion is described in Section 2. Indication Signaling.
3. The method of solution 1, wherein the first indication indicates one or more of following: activation of a specific cell or a specific cell group or deactivation of a specific cell or a specific cell group.
4. The method of solution 3, wherein the specific cell or the specific cell group further comprising a first cell of only uplink transmission is performed.
5. The method of solution 4, wherein the wireless communication device performs one or more of the following operations: transmitting a Sounding Reference Signal (SRS), reporting a Channel State Information (CSI), transmitting a Physical Uplink Control Channel (PUCCH), transmitting a Physical Shared Control Channel (PUSCH), transmitting a Random-Access Channel (RACH), or transmitting a preamble.
6. The method of solution 3, wherein the specific cell or the specific cell group further comprising a second cell of limited downlink service is performed.
7. The method of solution 6, wherein the wireless communication performs one or more of the following operations: transmitting a SRS, reporting a CSI, transmitting a PUCCH, transmitting a PUSCH, transmitting a RACH, processing a downlink common signal or channel with an extended periodicity, not processing a downlink common signal or channel, detecting a CSI-RS, or detecting on-demand reference signals.
8. The method of solution 6, wherein the specific cell or the specific cell group is configured with a particular downlink BWP; wherein the wireless communication device performs on the particular downlink BWP comprising one or more of the following operations: processing a downlink common signal or channel with an extended periodicity, not processing a downlink common signal or channel, detecting a CSI-RS, detecting on-demand reference signals, not monitoring the PDCCH, or not receiving DL-SCH (Downlink Shared Channel).
9. The method of solution 4, wherein the uplink BWP on the first cell is linked to a downlink BWP on a pre-determined cell.
10. The method of solution 4, wherein the first cell is associated with a pre-determined cell.
11. The method of solution 1, wherein the first indication further indicates deactivation of a downlink carrier, wherein the uplink transmission that corresponds to the deactivated downlink carrier is not stopped.
12. The method of any of solutions 9 or 11, wherein the uplink BWP on the uplink carrier or the first cell is linked to the downlink BWP on the pre-determined cell or the uplink carrier is associated with the pre-determined cell; and wherein the downlink carrier is deactivated.
13. The method of any of solutions 9 to 12, wherein the uplink BWP on the uplink carrier or the first cell is linked to the downlink BWP on the pre-determined cell further comprises one or more of the following: the scheduling information for a target is transmitted on the linked BWP, the indication information for the target is transmitted on the linked BWP, the reference RS used to obtain spatial relation of the UL transmission in the target is detected on the linked BWP, or the UL BWP and the linked BWP have the same Subcarrier Spacing (SCS); and wherein the target is the first cell or a uplink carrier.
14. The method of any of solutions of 9 to 12, wherein the uplink carrier or the first cell is associated with the pre-determined cell further comprises one or more of the following: the indication for the uplink carrier or the first cell is transmitted on the pre-determined cell, the corresponding timing reference frame of the uplink carrier or the first cell belongs to the pre-determined cell, the system frame boundary and system frame number of the uplink carrier or the first cell and the pre-determined cell are the same, the uplink carrier or the first cell and the pre-determined cell use a same timing advance group, a same timing advance offset value applies to both the uplink carrier or the first cell and pre-determined cell, the uplink frame in the uplink carrier or the first cell corresponds to the downlink frame in the pre-determined cell, the downlink reference signal of the uplink transmission in the uplink carrier or the first cell is transmitted on the pre-determined cell, or the pathloss difference between the uplink carrier or the first cell and the pre-determined cell is no larger than an offset.
15. The method of solution 1, wherein the second indication indicates a SCell state of one or more SCell or SCell group; wherein the SCell state comprises a first SCell state; and wherein the wireless communication device performs one or more of the following operations when the SCell is in the first SCell state: not monitoring a PDCCH, not processing a downlink common signal or channel, processing the downlink common signal or channel with an extended periodicity, detecting a CSI-RS, receiving on-demand reference signals, transmitting a SRS, reporting a CSI, transmitting PUCCH, transmitting PUSCH, or transmitting RACH.
16. The method of solution 1, wherein the third indication indicates a specific BWP in one or more SCell or SCell group.
17. The method of solution 16, wherein the specific BWP comprises at least one of the first downlink BWP or a second downlink BWP.
18. The method of any of solutions 16 or 17, wherein the wireless communication device performs one or more of the following on the first BWP: not monitoring the PDCCH; not receive DL-SCH; not processing the downlink common signal or channel; processing the downlink common signal or channel with an extended periodicity; detecting the CSI-RS; or receiving on-demand RS or SSB.
19. The method of solution 1, wherein the fourth indication indicates a specific BWP state in one or more SCell or SCell group; wherein the specific BWP state includes one or more of the following: specifically configured for a specific downlink BWP, configured with predefined characteristics, configured for any BWP, or configured for any BWP except dormant BWP.
20. The method of solution 19, wherein when the activated BWP is in the specific BWP state, wireless communication device does not receive downlink common signal or channel or receives limited downlink common signal or channel on the activated BWP.
21. The method of solution 1, wherein the fifth indication includes indication of one or more reference signal or reference signal resource; wherein the reference signal resource is configured for one of more of the following: fast SCell activation, synchronization, automatic gain control (AGC), transmission timing adjustment, or beam management.
22. The method of any of solutions 7, 8, 15, 18 or 20, wherein the downlink common signal or channel is a none-wireless communication device-specific downlink common signal or channel; wherein the downlink common signal or channel comprising one or more of the following: synchronization signal block (SSB), system information block (SIB), discovery burst, or paging.
23. The method of any of solutions 7, 8, 15, or 18, wherein the extended periodicity is determined by one or more of the following: configured by high layer parameter, multiple times of the default periodicity value of the signal on legacy secondary cells (SCell), the configurable maximum periodicity value for the signal on legacy SCell, or multiple times of the configurable maximum periodicity value of the signal on legacy SCell.
24. The method of any of solutions 9, 10, 12, 13, or 14, wherein the pre-determined cell comprising one or more of the following characteristics: configured by high layer parameter, be a primary cell (PCell) or primary secondary cells (PSCell), be in the same timing advance group (TAG) as a target cell, be in the same frequency range as the target cell, or the carrier frequency offset for the interval between the pre-determined cell and the target cell is no larger than a preset value.
25. The method of solution 2, wherein one or more of the first to fifth indication information is carried by MAC-CE signaling; wherein the MAC-CE is a SCell activation/deactivation MAC CE or an enhanced SCell activation/deactivation MAC-CE; and wherein a reserved bit value is used to indicate a type of the SCell to be activated or deactivated.
26. The method of solution 2, wherein one or more of the first to fifth indication information is carried by MAC-CE signaling; wherein the MAC CE is a first MAC-CE indicates SCell state; and wherein the MAC-CE comprises a field where each bit in the field corresponds to one cell state of a cell with a cell index.
27. The method of solution 2, wherein one or more of the first to fifth indication information is carried by DCI signaling, DCI further comprising one or more of the following: a first bit field where a bitmap or a codepoint indicates an active BWP of a SCell or a SCell group, a second bit field where the bitmap or the codepoint indicates a BWP state of the SCell or the SCell group, a third bit field the bitmap or the codepoint indicates a state of the SCell or the SCell group, a fourth bit field where the bitmap or the codepoint indicates activate or deactivate of one or more the SCell or the SCell group; or a fifth bit field where each bit associates a group of a resource signal resource set.
28. The method of solution 27, wherein a Hybrid Automatic Repeat Request Acknowledgement (HARQ-ACK) information in response to the DCI is provided after a duration from the last symbol of the PDCCH, where the duration is a positive value
29. A method of wireless communication (e.g., method 600 depicted in FIG. 6) including: transmitting, by a network device, to a wireless communication device, one or more of the following information: a first indication, a second indication, a third indication, a fourth indication or a fifth indication (602); wherein the first to fifth indication information include one or more of the following information: activations of a cell or a cell group (as described in Section 1.1), deactivation of the cell or the cell group (as described in Section 1.1), a cell state indication (as described in Section 1.2), a BWP indication (as described in Section 1.3), a BWP state indication (as described in Section 1.4), or a reference signal indication (as described in Section 1.5) (604); and operating the wireless communication device according to the transmitted indication (606). Detailed discussion is described in Section 1. Indication information.
30. The method of solution 29, wherein one or more of the first to fifth indication information is carried by one or more of the following transmission signals: a RRC signaling, a MAC-CE signaling, a DCI signaling, a reference signal, or a system information block. Detailed discussion is described in Section 2. Indication Signaling.
31. The method of solution 29, wherein the first indication indicates one or more of following: activation of a specific cell or a specific cell group or deactivation of a specific cell or a specific cell group.
32. The method of solution 31, wherein the specific cell or the specific cell group further comprising a first cell of only uplink reception is performed.
33. The method of solution 31, wherein the specific cell or the specific cell group further comprising a second cell of limited downlink service is transmitted.
34. The method of solution 33, wherein the network device performs one or more of the following operations: receiving a SRS, receiving a CSI report, detecting a PUCCH, receiving a PUSCH, detecting a RACH, transmitting a downlink common signal or channel with an extended periodicity, not transmitting downlink common signal or channel, transmitting a CSI-RS, or transmitting on-demand reference signals.
35. The method of solution 33, wherein the specific cell or the specific cell group is configured with a particular downlink BWP; wherein network device performs on the particular downlink BWP comprising one or more of the following operations: transmitting a downlink common signal or channel with an extended periodicity on the BWP, not transmitting a downlink common signal or channel on the BWP, transmitting a CSI-RS on the BWP, transmitting on-demand reference signals on the BWP, not transmitting the PDCCH on the BWP, or not transmitting DL-SCH on the BWP.
36. The method of solution 32, wherein the uplink BWP on the first cell is linked to a downlink BWP on a pre-determined cell.
37. The method of solution 32, wherein the first cell is associated with a pre-determined cell.
38. The method of solution 29, wherein the first indication further indicates deactivation of a downlink carrier, wherein uplink transmission that corresponds to the deactivated downlink carrier is not stopped.
39. The method of any of solutions 36 or 38, wherein the uplink BWP on the uplink carrier or the first cell is linked to the downlink BWP on the pre-determined cell and wherein the uplink carrier is associated with the pre-determined cell; wherein the downlink carrier is deactivated.
40. The method of any of solutions of 36 to 39, wherein the uplink BWP on the uplink carrier or the first cell is linked to the downlink BWP on the pre-determined cell further comprises one or more of the following: the scheduling information for the first cell is transmitted on the linked BWP, the indication information for the first cell is transmitted on the linked BWP, the reference RS used to obtain spatial relation of the UL transmission in the first cell is detected on the linked BWP, or the UL BWP and the linked BWP have the same SCS.
41. The method of any of solutions of 36 to 39, wherein the uplink carrier or the first cell is associated with the pre-determined cell further comprises one or more of the following: the indication for the uplink carrier or the first cell is transmitted on the pre-determined cell, the corresponding timing reference frame of the uplink carrier or the first cell belongs to the pre-determined cell, the system frame boundary and system frame number of the uplink carrier or the first cell and the pre-determined cell are the same, the uplink carrier or the first cell and the pre-determined cell use a same timing advance group, a same timing advance offset value applies to both the uplink carrier or the first cell and pre-determined cell, the uplink frame in the uplink carrier or the first cell corresponds to the downlink frame in the pre-determined cell, the downlink reference signal of the uplink transmission in the uplink carrier or the first cell is transmitted on the pre-determined cell, or the pathloss difference between the uplink carrier or the first cell and the pre-determined cell is no larger than an offset.
42. The method of solution 29, wherein the second indication indicates a SCell state of one or more SCells or SCell groups; wherein the SCell state comprises a first SCell state; and wherein the network device performs one or more of the following operations when the SCell is in the first SCell state: not transmitting a PDCCH, not transmitting a downlink common signal or channel, transmitting the downlink common signal or channel with an extended periodicity, transmitting CSI-RS, transmitting on-demand reference signals, receiving SRS, receiving CSI report, detecting PUCCH, receiving PUSCH, or receiving RACH.
43. The method of solution 29, wherein the third indication indicates a specific BWP in one or more SCells or SCell groups.
44. The method of solution 43, wherein the specific BWP comprises at least one of the first downlink BWP or a second downlink BWP.
45. The method of any of solutions 43 or 44, wherein the network device performs one or more of the following on the first BWP: not transmitting the PDCCH on the BWP; not transmitting DL-SCH on the BWP; not transmitting the downlink common signals/channels on the BWP; transmitting the downlink common signals/channels with an extended periodicity on the BWP; transmitting the CSI-RS on the BWP; or transmitting on-demand RS or SSB on the BWP.
46. The method of solution 29, wherein the fourth indication indicates a specific BWP state in one or more SCells or SCell groups; wherein the specific BWP state includes one or more of the following: specifically configured for a specific downlink BWP, configured with predefined characteristics, configured for any BWP, or configured for any BWP except dormant BWP.
47. The method of solution 46, wherein when the activated BWP is in the specific BWP state, network device does not transmit downlink common signal or channel or transmit limited downlink common signal or channel on the activated BWP.
48. The method of solution 29, wherein the fifth indication includes indication of one or more reference signal or reference signal resource; wherein the reference signal resource is configured for one of more of the following: fast SCell activation, synchronization, automatic gain control (AGC), transmission timing adjustment, or beam management.
49. The method of any of solutions 34, 35, 42, 45 or 47, wherein the downlink common signal or channel is a none-wireless communication device-specific downlink common signal or channel; wherein the downlink common signal or channel comprising one or more of the following: SSB, SIB, discovery burst, or paging.
50. The method of any of solutions 34, 35, 42, or 45, wherein the extended periodicity is determined by one or more of the following: configured by high layer parameter, multiple times of the default periodicity value of the signal on legacy secondary cells (SCell), the configurable maximum periodicity value for the signal on legacy SCell, or multiple times of the configurable maximum periodicity value of the signal on legacy SCell.
51. The method of any of solutions 36, 37, 39, 40, or 41, wherein the pre-determined cell comprising one or more of the following characteristics: configured by high layer parameter, be a PCell or PSCell, be in the same TAG as a target cell, be in the same frequency range as the target cell, or the carrier frequency offset for the interval between the pre-determined cell and the target cell is no larger than a preset value.
52. The method of solution 30, wherein one or more of the first to fifth indication information is carried by MAC-CE signaling; wherein the MAC-CE is a SCell Activation/Deactivation MAC CE or an enhanced SCell Activation/Deactivation MAC-CE; and wherein a reserved bit value is used to indicate a type of the SCell to be activated or deactivated.
53. The method of solution 30, wherein one or more of the first to fifth indication information is carried by MAC-CE signaling; wherein the MAC CE is a first MAC-CE indicates SCell state; and wherein the MAC-CE comprises a field where each bit in the field corresponds to one Cell state of a cell with a cell index.

54. The method of solution 30, wherein one or more of the first to fifth indication information is carried by DCI signaling, DCI further comprising one or more of the following: a first bit field where a bitmap or a codepoint indicates an active BWP of a SCell or a SCell group, a second bit field where the bitmap or the codepoint indicates a BWP state of the SCell or the SCell group, a third bit field the bitmap or the codepoint indicates a state of the SCell or the SCell group, a fourth bit field where the bitmap or the codepoint indicates activate or deactivate of one or more the SCell or the SCell group; or a fifth bit field where each bit associate a group of a resource signal resource set.
55. The method of solution 54, wherein a HARQ-ACK information in response to the DCI is provided after a duration from the last symbol of the PDCCH, where the duration is a positive value.
56. An apparatus for wireless communication comprising a processor configured to implement the method of any of solutions 1 to 55.
57. A computer readable medium having code stored thereon, the code when executed by a processor, causing the processor to implement a method recited in any of solutions 1 to 55.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this document.

What is claimed is:

1. A method of wireless communication, comprising:
receiving, by a wireless communication device, from a network device, one or more of: a first indication, a second indication, a third indication, a fourth indication or a fifth indication;
wherein the first to fifth indication include: a cell or a cell group activation indication, a cell or a cell group deactivation indication, a cell state indication, a Bandwidth Part (BWP) indication, a BWP state indication, or a reference signal indication; and
operating the wireless communication device according to the receiving.

2. The method of claim 1, wherein the first indication indicates one or more of: activation of a specific cell or a specific cell group, deactivation of a specific cell or a specific cell group, or deactivation of a downlink carrier, and
wherein an uplink transmission that corresponds to the deactivated downlink carrier is not stopped.

3. The method of claim 2, wherein the specific cell or the specific cell group further comprises at least one of a first cell performing only an uplink transmission, or a second cell performing a limited downlink service.

4. The method of claim 3, wherein an uplink BWP on the first cell is linked to a downlink BWP on a pre-determined cell, or wherein the first cell is associated with the pre-determined cell.

5. The method of claim 4, wherein the uplink BWP on an uplink carrier or on the first cell is linked to the downlink BWP on the pre-determined cell or the uplink carrier is associated with the pre-determined cell, and wherein a downlink carrier, corresponding to the uplink BWP or the uplink carrier, is deactivated.

6. The method of claim 4,
wherein the uplink BWP on an uplink carrier or on the first cell is linked to the downlink BWP on the pre-determined cell further comprises one or more of the following: a scheduling information for a target is transmitted on the linked downlink BWP, an indication information for the target is transmitted on the linked downlink BWP, a reference RS used to obtain spatial relation of an uplink (UL) transmission in the target is detected on the linked downlink BWP, or the UL BWP and the linked downlink BWP have a same Subcarrier Spacing (SCS), and
wherein the target is the first cell or the uplink carrier.

7. The method of claim 4, wherein an uplink carrier or the first cell is associated with the pre-determined cell further comprises one or more of: an indication for the uplink carrier or the first cell is transmitted on the pre-determined cell, a corresponding timing reference frame of the uplink carrier or the first cell belongs to the pre-determined cell, a system frame boundary and system frame number of the uplink carrier or the first cell and of the pre-determined cell are the same, the uplink carrier or the first cell and the pre-determined cell use a same timing advance group, a same timing advance offset value applies to both the uplink carrier or the first cell and the pre-determined cell, an uplink frame in the uplink carrier or the first cell corresponds to a downlink frame in the pre-determined cell, a downlink reference signal of the uplink transmission in the uplink carrier or the first cell is transmitted on the pre-determined cell, or a pathloss difference between the uplink carrier or the first cell and the pre-determined cell is no larger than an offset.

8. The method of claim 1, wherein the second indication indicates a secondary cell (SCell) state of one or more SCell or SCell group,
wherein the SCell state comprises a first SCell state, and
wherein the wireless communication device performs one or more of the following operations when the SCell is in the first SCell state: not monitoring a Physical Downlink Control Channel (PDCCH), not processing a downlink common signal or channel, processing the downlink common signal or channel with an extended periodicity, detecting a Channel State Information Reference Signal (CSI-RS), receiving on-demand reference signals, transmitting a Sounding Reference Signal (SRS), reporting a Channel State Information (CSI), transmitting Physical Uplink Control Channel (PUCCH), transmitting Physical Uplink Shared Channel (PUSCH), or transmitting Random-Access Channel (RACH).

9. The method of claim 1, wherein the third indication indicates a specific BWP in one or more secondary cell (SCell) or SCell group, and
wherein the specific BWP comprises at least one of a first downlink BWP or a second downlink BWP, and wherein the wireless communication device performs one or more of the following on the first downlink BWP: not monitoring a Physical Downlink Control Channel (PDCCH); not receive a Downlink Shared Channel (DL-SCH); not processing a downlink common signal or channel; processing the downlink common signal or channel with an extended periodicity; detecting a Channel State Information Reference Signal (CSI-RS); or receiving an on-demand reference signal (RS) or synchronization signal block (SSB).

10. The method of claim 1, wherein the fourth indication indicates a specific BWP state in one or more secondary cell (SCell) or SCell group,
wherein the specific BWP state includes one or more of the following: specifically configured for a specific downlink BWP, configured with predefined characteristics, configured for any BWP, or configured for any BWP except a dormant BWP, and
wherein when an activated BWP is in the specific BWP state, the wireless communication device does not receive a downlink common signal or channel or receives a limited downlink common signal or channel on the activated BWP.

11. The method of claim 1, wherein the fifth indication includes indication of one or more reference signal or reference signal resource, and
wherein the reference signal resource is configured for one or more of the following: fast secondary cell (SCell) activation, synchronization, automatic gain control (AGC), transmission timing adjustment, or beam management.

12. The method of claim 4, wherein the pre-determined cell comprises one or more of following characteristics: configured by a high layer parameter, be a primary cell (PCell) or primary secondary cells (PSCell), be in a same timing advance group (TAG) as a target cell, be in a same frequency range as the target cell, or a carrier frequency offset for an interval between the pre-determined cell and the target cell is no larger than a preset value.

13. The method of claim 1, wherein one or more of the first to fifth indication information is carried by a Medium Access Control-Control Element (MAC-CE) signaling,
wherein the MAC-CE is a secondary cell (SCell) activation/deactivation MAC-CE or an enhanced SCell activation/deactivation MAC-CE, and
wherein a reserved bit value is used to indicate a type of the SCell to be activated or deactivated.

14. The method of claim 1, wherein one or more of the first to fifth indication information is carried by a downlink control information (DCI) signaling, and wherein the DCI further comprises one or more of the following: a first bit field where a bitmap or a codepoint indicates an active BWP of a secondary cell (SCell) or a SCell group, a second bit field where the bitmap or the codepoint indicates a BWP state of the SCell or the SCell group, a third bit field where the bitmap or the codepoint indicates a state of the SCell or the SCell group, a fourth bit field where the bitmap or the codepoint indicates activate or deactivate of one or more the SCell or the SCell group, or a fifth bit field where each bit associates a group of a resource signal resource set.

15. The method of claim 14, wherein a Hybrid Automatic Repeat Request Acknowledgement (HARQ-ACK) information in response to the DCI is provided after a duration from a last symbol of a Physical Downlink Control Channel (PDCCH), where the duration is a positive value.

16. A method of wireless communication, comprising:
transmitting, by a network device, to a wireless communication device, one or more of: a first indication, a second indication, a third indication, a fourth indication or a fifth indication,
wherein the first to fifth indication include one or more of: a cell or a cell group activation indication, a cell or a cell group deactivation indication, a cell state indication, a Bandwidth Part (BWP) indication, a BWP state indication, or a reference signal indication; and
operating the network device according to the transmitted indication.

17. An apparatus for wireless communication comprising at least one processor configured to:
receive, from a network device, one or more of: a first indication, a second indication, a third indication, a fourth indication or a fifth indication,
wherein the first to fifth indication include: a cell or a cell group activation indication, a cell or a cell group deactivation indication, a cell state indication, a Bandwidth Part (BWP) indication, a BWP state indication, or a reference signal indication; and
operate the apparatus according to the received indication.
